(19) United States
(12) Patent Application Publication
(10) Pub. No.: US 2009/0218297 A1
(43) Pub. Date: Sep. 3, 2009

(54) WATER INTAKE SYSTEM FILTER

(75) Inventors: David Lee Glessner, Houston, TX (US); Michael Webster Sparks, Houston, TX (US); Constantyn Engelbert Gieskes, Houston, TX (US)

Correspondence Address: PATTERSON & SHERIDAN, L.L.P., 3040 POST OAK BOULEVARD, SUITE 1500, HOUSTON, TX, 77056, US

(73) Assignee: NORTHERNSTAR NATURAL GAS INC., Houston, TX (US)

(21) Appl. No.: 12/402,403

(22) Filed: Mar. 11, 2009

Related U.S. Application Data
(63) Continuation-in-part of application No. 12/044,708, filed on Mar. 7, 2008.
(60) Provisional application No. 60/893,581, filed on Mar. 7, 2007.

(51) Int. Cl. B63B 13/02; B01D 35/02; B01D 29/00

(52) U.S. Cl. 210/767; 210/162; 210/85

(57) ABSTRACT

A method and apparatus for a marine vessel water intake filtering system is described. The apparatus includes a filtering device adapted to couple to the marine vessel over a water intake port in the hull of the vessel. The filtering device lowers the flow velocity of the water on the incoming surface of the filter while maintaining a suitable flow to the intake port of the vessel. The filtering device prevents marine species of a certain size from becoming entrained in the water flow and entering the intake port, and provides for marine species that may be in the area of the intake do not become impinged on the filtering device as a result of intake water flow velocity.

### CROSS-REFERENCE TO RELATED APPLICATIONS

This application is a continuation-in-part of U.S. patent application Ser. No. 12/044,708, filed Mar. 7, 2008, which claims benefit of U.S. Provisional Patent Application Ser. No. 60/893,581, filed Mar. 7, 2007, both applications are hereby incorporated by reference herein.

### BACKGROUND OF THE INVENTION

1. Field of the Invention

The present invention generally relates to water collection systems for ballast water, cooling water, and auxiliary service water on naval vessels. More particularly, this invention relates to a system and method for filtering water before reaching the vessel ballast, cooling, and auxiliary systems.

2. Description of the Related Art

Naval vessels, such as cargo ships and cruise ships, have been used for years to transport cargo and/or people from port to port all over the world. The ports are typically located onshore near a body of water, and the ships are typically moored nearby to facilitate loading and unloading of the cargo or people. To provide for the operation of the vessel, there are provisions for the vessel to bring aboard surrounding water for the purposes of ballast, cooling, and other miscellaneous auxiliary services. Generally, surrounding water brought aboard a vessel falls into one of two categories, one being ballast water and the other being cooling or auxiliary service water.

Typically, naval vessels are configured to displace a specific amount of water in order to maintain stability and/or provide maneuverability in the water, among other factors, and ballast water may facilitate this displacement. Ballast water may be water which is gathered and retained aboard until discharged at, or enroute to, a different location or port. To facilitate displacement of the vessel, the vessel typically includes one or more integral ballast tanks configured to receive and store the water, and to expel the water when desired. The water used to fill the ballast tanks is typically gathered from the water around the vessel, and the ballast tanks may be filled or purged by an onboard system of pumps that are in communication with the ballast tanks on the vessel.

To provide for the operation of machinery and equipment on board the naval vessel, water is needed to perform any variety of duties. Cooling or auxiliary service water may be water brought aboard for the purposes of cooling equipment or machinery, or performing some other required duty aboard the vessel, and the water is generally discharged back into the surrounding water on completion of the duty. Typically, vessels will be provided propulsive and/or electrical power through diesel, steam, or gas turbine prime movers. In some cases, excess heat required to be removed from this equipment in the course of its operation is done through the transfer of heat to water that is taken from the surrounding area, put into the required service aboard the vessel, and thereupon returned by discharging the water back into the surrounding environment. In other cases, the water may be needed aboard the vessel to perform duties unrelated to power development. These activities could include providing sealing water for rotating equipment or other equipment, providing water for firefighting, supply water for reverse osmosis filtration or other types of distillation plants, and providing for sanitary water requirements, among other uses.

The water supplied for the purposes of use in ballast tanks, cooling water, and/or auxiliary services is typically gathered by inlet conduits or intakes, sometimes referred to as sea chest openings, that are integral to the vessel hull and in communication with the ballast tanks or other systems for which the water is required. While these inlet conduits may include a grating or mesh to filter large debris during operation, the gratings typically do not exclude smaller debris and/or marine life, such as aquatic species of plants and animals. The introduction of certain marine life into the vessel's water intake system, for example fish species inadvertently pulled into the inlet conduit, may injure or kill the fish irrespective of the duty the water will perform aboard the vessel. Moreover, in the case of water brought aboard for ballast service, any marine biota surviving transfer into a ballast tank will be locationally displaced. This injury, unintentional eradication, or locational displacement of the fish may negatively impact the ecological balance in the body of water in which the vessel is docked, and the possibility of negative environmental impact to fish may limit the docking or landing possibilities of the vessel. For example, estuaries, preserves, and other ecologically sensitive or protected marine areas may not be available as potential landing sites for the vessel. This limited docking potential may, in turn, prevent or minimize commercial ventures in certain areas, or may limit the availability of certain products in an area where the products may be used, thus requiring the products to be off-loaded at distant ports and transported to the area by alternate means.

As interest in ecologically sensitive areas grows, companies and other commercial interests desiring to create landing sites have become more cognizant of the fragile ecological balances in these areas. Some of these companies have made commitments to operating in these areas in a manner that not only maintains the ecological balance, but monitors and reacts to ecological shifts in these areas in an effort to enhance the ecosystem. Challenges exist for these companies as the typical vessel to be moored at the landing site may be an older vessel and/or is not equipped to limit impact to the area due to the age of the vessel, or the vessel is mechanically deficient of some apparatus that may limit environmental impact. For example, the companies that operate the landing sites often do not have a say in the age or manufacture of the vessel that is used to transport the cargo to the landing site. Thus, these companies have been challenged to make these vessels more ecologically friendly without major redesigns in the vessel itself.

Therefore, there is a need in the industry for a water intake filtering system that minimizes or eliminates intake of, and injury to, marine life while maintaining an acceptable flow of water to support vessel requirements.

### SUMMARY OF THE INVENTION

The invention generally provides methods and apparatus for marine vessel water intake systems. In one embodiment, a filter is described. The filter includes a frame, a plurality of movable legs, disposed around a perimeter of the frame, at least one motor coupled to each of the plurality of movable legs, a temporary connector coupled to each of the plurality of movable legs, each temporary connector being actuatable to couple to a hull of a marine vessel, and a covering coupled between opposing sides of the frame to define a surface area that is at least two times greater than an area defined by the opening in the hull.

In another embodiment, a filter configured to attach to a hull of a vessel adjacent to an opening in the hull, the opening having an surface open area configured to receive a volume of water at first flow velocity is described. The filter includes a frame and a covering attached to the frame having a surface area that is greater than the open area and defining an interstitial space between the hull and an interior surface of the covering, a perforated plate coupled between the hull and the covering, and a plurality of temporary connectors spaced along the perimeter of the frame, wherein the covering maintains the volume of water at a second flow velocity that is less than the first flow velocity.

In another embodiment, a method for filtering marine species from water surrounding a marine vessel is described. The method includes coupling a removable filter to the marine vessel over an opening in the hull, moving water through an area exterior to an outer surface of the removable filter at a first velocity, and moving the filtered water through the opening in the hull at a second velocity that is greater than the first velocity.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an exemplary landing site.

FIG. 2 is an elevation view of a portion of the vessel from FIG. 1.

FIG. 3A is an isometric top view of one embodiment of a filter.

FIG. 3B is a cross-sectional view of a portion of the filter and a hull taken along section 3B-3B from FIG. 3A.

FIG. 4A is an isometric top view of one embodiment of a filter.

FIG. 4B is an exploded isometric detail view taken from FIG. 4A.

FIG. 5 is an isometric top view of another embodiment of a filter.

FIG. 6A is a top view of another embodiment of a filter.

FIG. 6B is a side cross-sectional view of one embodiment of a flow diverter.

FIG. 6C is a side cross-sectional view of another embodiment of a flow diverter.

FIG. 7 is an isometric view of a portion of one embodiment of a covering.

FIG. 8A is an isometric top view of another embodiment of a filter.

FIG. 8B is an isometric detail view of a portion of the filter shown in FIG. 8A.

FIG. 9 is an isometric detail view of one embodiment of an articulatable leg.

FIG. 10 shows one embodiment of a movement sequence for a filter.

FIG. 11 is a side view of one embodiment of a filter positioned on a vessel hull adjacent an opening.

To facilitate understanding, identical reference numerals have been used, where possible, to designate identical elements that are common to the figures. It is also contemplated that elements and features of one embodiment may be beneficially incorporated on other embodiments without further recitation.

### DETAILED DESCRIPTION

The present invention generally relates to water collection systems for filling intake water on naval vessels and may be exemplarily described for use on cargo ships, but embodiments described herein may be used on any vessel that requires intake water to perform required service or fulfill a need upon the vessel. Examples include cruise ships, submarines, personal watercraft, and any other marine vessel configured to gather, store, and expel ballast water, and/or gather, use, and discharge cooling and/or auxiliary service water. Although the invention is exemplarily described with respect to ballast, cooling, and auxiliary water systems aboard these vessels, embodiments described herein may also be adapted to filter incoming water used in other water intake systems aboard the vessels as well.

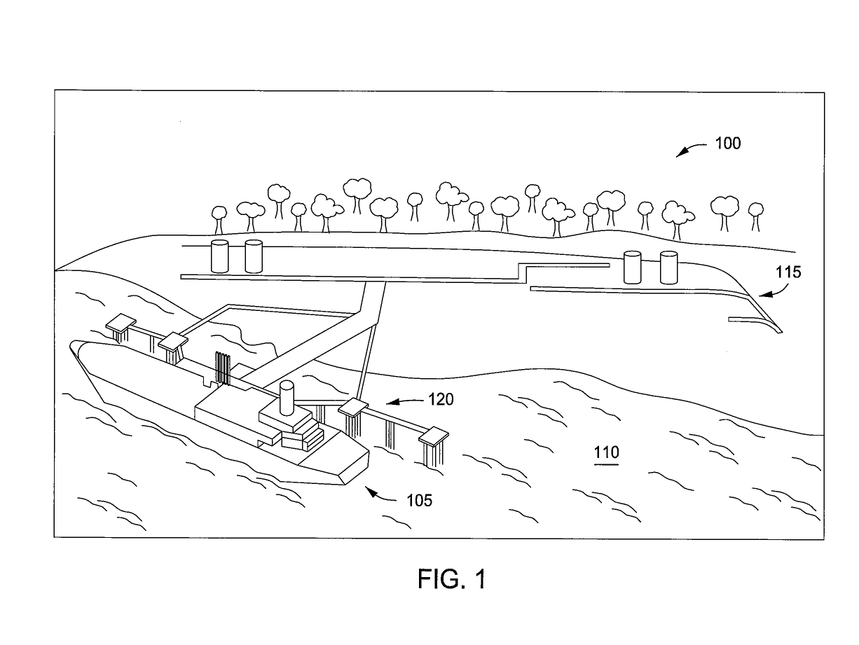

FIG. 1 is a perspective view of an exemplary landing site 100 having a vessel 105 in a body of water 110 adjacent a processing facility 115 located onshore. The vessel 105 is shown moored to a docking facility 120 that extends at least partially from the shore into the body of water 110. The body of water 110 may be any body of water suitable for a landing site for the vessel 105 and the docking facility 120 may be between several feet to a thousand or more feet from the shore. In this example, the processing facility 115 may be a liquefied natural gas (LNG) processing facility configured to process LNG off-loaded from the vessel 105.

The docking facility 120 provides a stable platform for loading and unloading cargo, such as LNG in this example. Conduits, such as pipes and hoses, to facilitate loading and unloading of the LNG to and from the processing facility 115 and the vessel 105 may be coupled to the docking facility 120 or in the body of water 110 between the vessel 105 and the processing facility 115. Other supplies, such as fuel, food, and other items used on the vessel 105, may be transferred to or from the vessel 105 by using the docking facility 120.

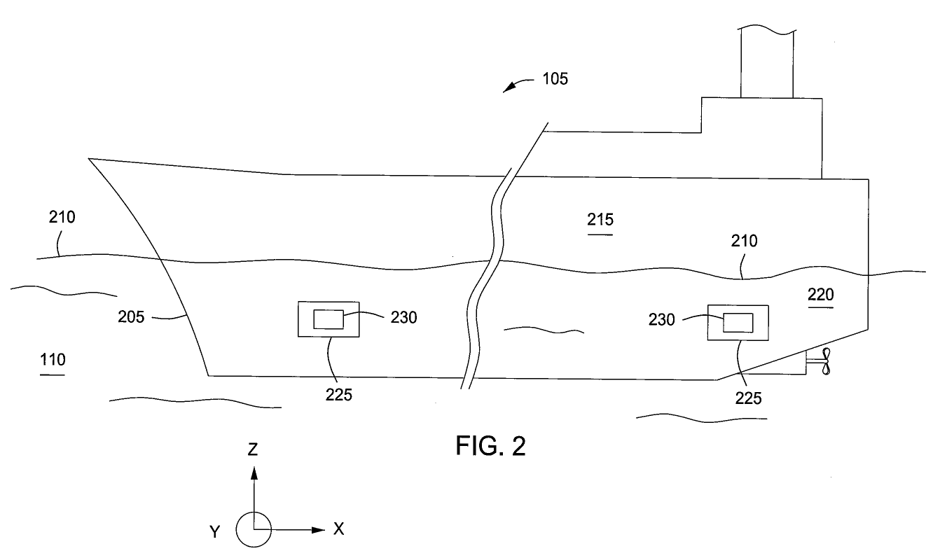

FIG. 2 is an elevation view of a portion of the vessel 105 shown in FIG. 1. The vessel 105 includes a hull 205 having an upper portion 215 above a waterline 210 and a lower portion 220 below the waterline 210. The lower portion 220 includes one or more openings 230, sometimes referred to as sea chest openings, that are spaced along the length of the hull 205 below the waterline 210. Each of the openings 230 are in communication with a ballast tank or tanks (not shown) integral to the interior of the hull 205 and are configured to transfer water to the ballast tanks. In other applications, one or more of the openings 230 may be in communication with cooling systems or an auxiliary service system aboard the vessel and the opening is appropriately routed to support equipment or adapted for machinery cooling, or another auxiliary service requirement. While the openings 230 are shown as rectangular, the openings may be any shape, such as circular, oval, or square.

As mentioned above, the openings 230 may include a grating or mesh to minimize the introduction of debris into the openings 230, but typically do not control the introduction of marine life, particularly fish species, into the water intake systems of the vessel. In this embodiment, each of the openings 230 include a filter 225 attached to the hull 205 and positioned over the openings 230 to minimize or eliminate the introduction of marine life into the openings 230. The filter 225 is adapted to be at least partially flexible to conform to the shape of the outer surface of the hull 205 while maintaining sufficient rigidity and mechanical strength to act as a filter, and may be removably coupled to the hull 205 while the ship is docked by the use of coupling devices (described below). Each filter 225 may be positioned and attached over the openings 230 by a dockside or vessel crane, or divers may be employed to position and attach the filters 225. Before the vessel leaves the port, each filter 225 may be removed by a crane or divers.

The filter 225 as described herein is adapted to decrease incoming water flow velocity at or near the outer surface of the filter 225 while maintaining volumetric flow to the opening 230. In one embodiment, the surface area of at least the outer surface of the filter 225 is greater than the area of the opening 230, thereby minimizing the flow velocity at the outer surface of the filter while maintaining a suitable volumetric flow at the opening 230. In one application, the surface area of the filter 225 is at least two times greater than the area of the opening 230, while in other applications, the surface area of the filter 225 is three, four, five, or six times greater than the area of the opening 230.

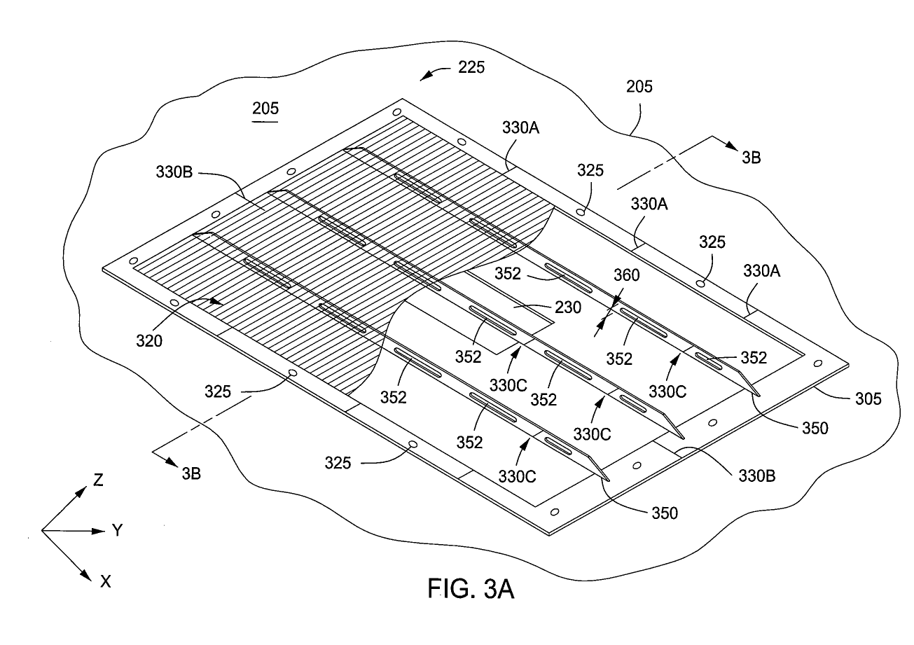

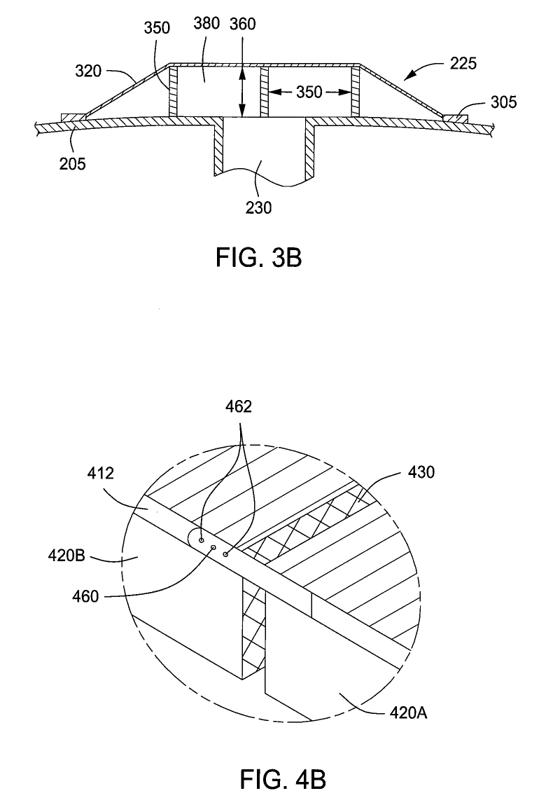

FIG. 3A is an isometric top view of one embodiment of a filter 225 attached to a base structure, which in this Figure is the hull 205. The filter 225 includes a polygonal frame 305 having a covering 320 attached thereto. The covering 320 may be a mesh, a screen, a sieve, or any other suitable filtering device. For example, the covering 320 may be a perforated plate, a mesh or woven wire, or a plurality of filtering members as described below in reference to FIG. 7. The covering 320 is adapted to have at least about a 25% open area and includes openings that are preferably between about 0.05 inches to about 0.1 inches. The covering 320 may be made of polymers, such as plastic, elastomers, such as saturated or unsaturated rubbers, or may be made of metallic materials, such as brass, copper, aluminum, or stainless steel.

In one embodiment, the covering 320 is adapted to flex to accommodate the curvature of the hull 205 while maintaining structural rigidity of the covering 320. For example, the frame 305 is adapted to flex or conform to the shape of the hull 205, and is made of conformal materials, such as rubber, plastics, elastomers and the like. The frame 305 may also be made of metallic materials, such as stainless steel, aluminum, brass and the like. The metallic materials may include a spring-like property or be made of sheet metal that may easily bend while retaining sufficient mechanical integrity to prevent permanent bends or creases in the frame, or may include a shape memory alloy (SMA). The frame 305 may also include flexible portions 330A and 330B to facilitate conformity of the frame 305 to the hull 205 by enhancing structural strength of at least the covering 320, while facilitating flexibility of the frame 305. The flexible portions 330A and 330B may be portions of the frame 305 material having a thinner, more flexible cross-section, or the flexible portions may be fasteners, such as hinges, springs, coupling devices, and the like, that are coupled between sections of the frame 305. In one application, the flexible portions 330A, 330B may be a magnetic material to facilitate coupling of the frame 305 to the hull 205, and in one embodiment, the magnetic material may be flexible or include a fastener coupled between the magnetic material and sections of the frame 305.

The covering 320 is generally spaced apart from the hull 205 to define an intermediate area, shown as an interstitial area 380 in FIG. 3B below, that is defined between an outer surface of the hull 205 and the inner surface of the covering 320. The intermediate area serves to transition the velocity of incoming water to the outer surface of the covering 320 relative to the velocity of the incoming water to the opening 230. The intermediate area may be formed and maintained by the materials and construction of the filter 225, such as the rigidity of the covering, and in some applications, the filter 225 may include one or more support members 350 configured to support the covering 320 and space the covering 320 apart from the hull 205 by a stand-off distance 360. The support members 350 may also include openings 352, such as slots or holes, configured to provide enhanced flow of water in the intermediate area and may also serve to lighten the weight of the filter 225.

FIG. 3B is a cross-sectional view of a portion of the filter 225 and hull 205 taken along section 3B-3B from FIG. 3A. As an example, the curvature of the hull 205 is shown in this view, and the covering 320, at least between the support members 350, is spaced apart from and generally follows the curvature of the hull 205. In one embodiment, an intermediate area 380, that may be defined as the spacing between the hull 205 and the covering 320, is between about 4 inches to about 12 inches, and is defined at least partially by the stand-off distance 360. In one application, the intermediate area 380 may be at least partially defined by the volume defined between the hull 205 and the inner surface of the covering 320. In this embodiment, the covering 320, at least between the support members 350, is substantially equally spaced away from the hull 205 and the covering 320. In other embodiments (not shown), the spacing-apart of the covering 320 and the hull 205 may be different, which may be produced by varying the stand-off distance 360 of each of the support members 350. For example, the stand-off distance 360 of a center support member may be a greater distance than the outer support members 350, which may be provided by differing cross-sectional dimensions of the support members 350.

In the example shown in FIGS. 3A and 3B, each support member 350 is coupled to the frame and provides a suitable spacing between the hull 205 and the inner surface of the covering 320 to maintain the intermediate area 380 between the hull 205 and the covering 320. The support members 350 are adapted to flex to facilitate conformity of the filter 225 to the hull 205 while maintaining structural integrity of the filter 225. The support members 350 may be made of the same materials as the frame 305 and in some applications, the support members 350 may include one or more flexible portions 330C that are configured similar to the flexible portions 330A and 330B described above.

To facilitate coupling of the filter 225 to the hull 205, the frame includes a plurality of temporary connectors 325, which may be magnetic members, suction devices, vacuum devices, and combinations thereof. In one application, at least a portion of the plurality of temporary connectors 325 are mechanically actuatable magnets that may be actuated manually or remotely by a switch or lever. In another application, electrically actuated magnets may be used, and the magnets may be actuated by a remote actuation system or manually by a diver. In another application where the condition of the hull allows, at least a portion of the temporary connectors 325 are suction or vacuum devices that may be configured to hold and release by a mechanical lever, or the vacuum device may include a hose coupled to a source of negative pressure to maintain suction and coupling of the filter 225 to the hull 205.

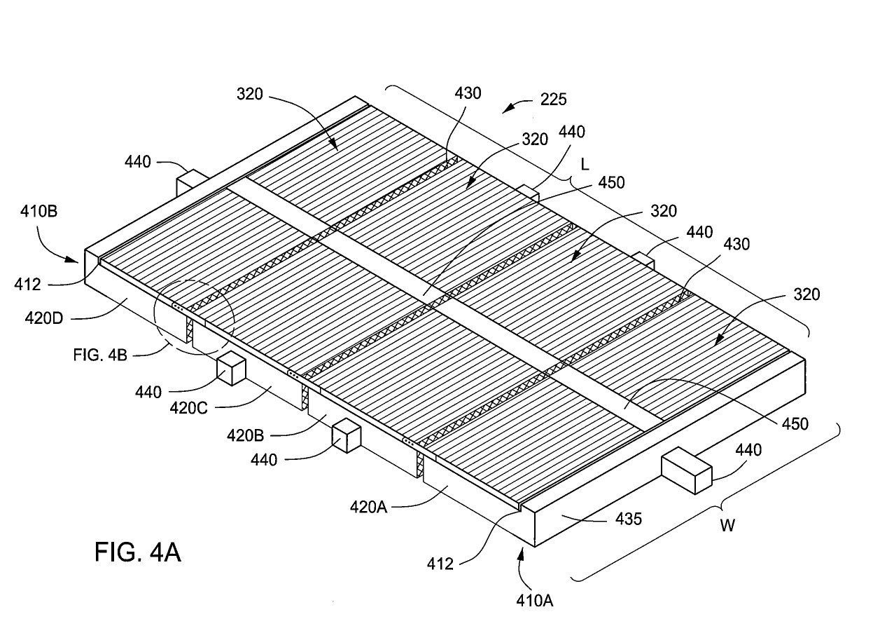

FIG. 4A is an isometric top view of another embodiment of a filter 225. In this embodiment, the filter 225 includes a frame comprising two end caps 410A, 410B and one or more filter sections, which are shown as sections 420A-420D, coupled therebetween. Each end cap 410A, 410B may be solid or include a tubular cross-section and is adapted to couple to a portion of a filter section, such as section 420A and 420D. Additional filter sections, such as 420B and 420C may be added to the filter 225, as needed, such as by placing an additional section (420A and/or 420C) adjacent and between each end cap 410A, 410B. The filter sections 420A, 420D may be permanently or removably attached to respective end caps 410A, 410B, or may be held in position by temporary connector, such as a magnet, suction devices, and the like, or other fasteners, such as bolts or screws. In one embodiment, the filter sections 420B and 420C may be removably joined at an interface 430. In this embodiment, the filter 225 is configurable as the filter sections 420B-420C may be added or removed as needed, or additional filter sections (not shown) may be added as needed, to adjust the size of the filter 225. In one embodiment, the filter sections 420A and 420D are adapted to attach to respective end caps 410A, 410B along the structural edges of the filter section to permit unimpeded flow of water through the covering 320.

Each end cap 410A, 410B includes a housing 440 that may include a temporary connector, such as a magnet, a suction device, and the like, as described in reference to FIG. 3A. In one embodiment, each end cap 510A, 510B may include an end section 435 having a housing 440 that provides a connection point for the end caps 510A, 510B. In some applications, the end section includes other temporary connectors (not shown) disposed in locations other than the housing 440. In other applications, the filter sections may include housings 440 that may include temporary connectors (not shown) to facilitate attachment at points along the length L of the filter 225.

In one embodiment, each filter section 420A-420D may include a structural member 450 that is adapted to enhance the mechanical strength and rigidity of the covering 320 and/or the filter 225. For example, each filter section 420A-420D may include one or more structural members 450 that serve as an attachment point for the covering 320 while also adding mechanical strength to the filter section. In one application, filter sections 420A and 420D are coupled on one end to respective end caps 410A, 410B by any fastening device or method, such as welding, adhesives, clamps, screws, bolts, rivets, snaps, a hook and loop type fastener, or any other suitable fastening device or method. In one specific embodiment, each end cap 410A, 410B and/or section 420A-420D includes a recess 412 formed therein that is adapted to receive a portion of a respective filter section. As an example, an extended member 460 on filter sections 420A, 420D, such as a rod or bar, may extend out of the respective section to be received in the recess 412 as shown in FIG. 4B. The extended member 460 may be coupled to a respective filter section by fasteners 462, which may be bolts, screws, rivets, hook and loop connectors, or combinations thereof. In one embodiment, the filter section adjacent each end cap may be attached by a plurality of fasteners (not shown), such as bolts, screws, clamps, and the like and at least a portion of the fasteners are configured to secure a portion of an extended member 460 to the respective end cap.

In this embodiment, the width “W” may be any desired width that may be determined before manufacture, and the length “L” may be configurable or modular. For example, each filter section 420A-420D may be added as needed in order to increase the length L of the filter 225, which increases the surface area of the filter 225. Additional filter sections 420B, 420C may be coupled to the respective filter sections 420A, 420D at the interface 430 between the respective sections to adjust the length L. Each interface 430 may be a plurality of fasteners, such as bolts or screws, clamps, and the like, and is adapted to attach and detach easily. In one embodiment, one filter section may include an extended member 460, such as a bar or rod, that is adapted to be received by an adjacent filter section, which may be fastened together as described above. In one embodiment, the interface 430 comprises a hook and loop fastener made of a corrosion resistant material, such as stainless steel. The end caps 410A, 410B may be made of SMA's, elastomers or polymers, such as plastics, or corrosion resistant metals that may include a spring-like property to facilitate slight bends to conform to the shape of the hull (not shown in this view). Likewise, each interface 430 is adapted to bend slightly to facilitate conformation of the filter 225 to the hull 205.

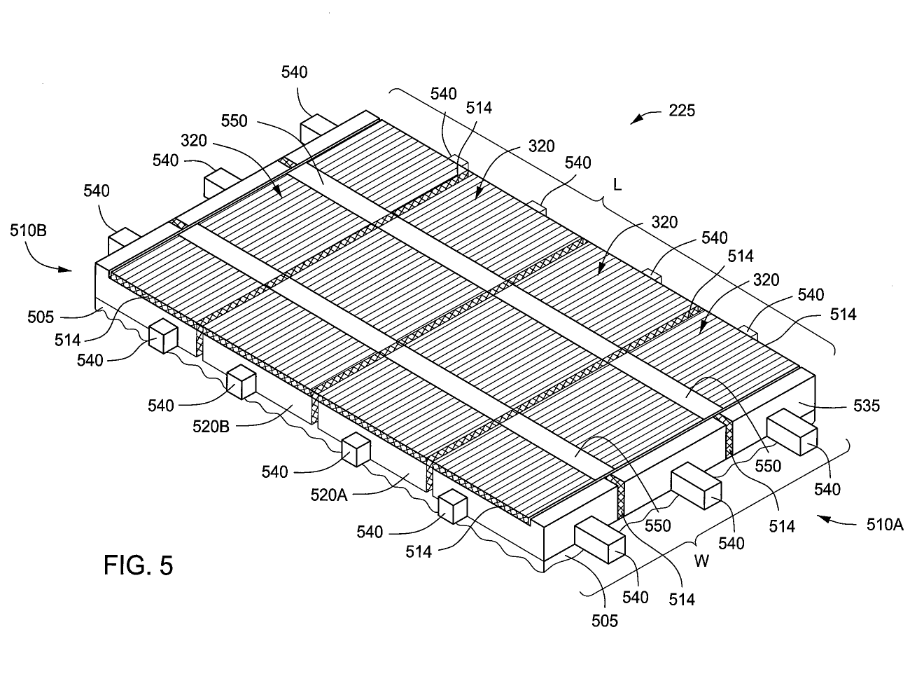

FIG. 5 is an isometric top view of another embodiment of a filter 225 that is similar to the filter 225 of FIG. 4A with the exception of differences in the end caps 510A, 510B and the addition of a conformal material 505 along the lower surface of the end caps 510A, 510B and filter sections 520A, 520B. In this embodiment, the end caps 510A and 510B include elongated ends that serve to provide additional mechanical strength to the filter 225 and include the covering 320 attached thereto. In one embodiment, each filter section 520A, 520B and/or end cap 510A, 510B may include one or more structural members 550 that are adapted to enhance the mechanical strength and rigidity of the covering 320. The end caps 510A, 510B also include a plurality of housings 540 that may include temporary connectors, such as magnets, suction devices, and the like.

In one embodiment, each end cap 510A, 510B may include a center section 535 having at least one housing 540 for a temporary connector as described above. Each end cap 510A, 510B also includes one or more flexible interfaces 514, as well as flexible interfaces 514 between end caps and filter sections 520A, 520B. The flexible interfaces 514 may include flexible materials or devices allowing flexibility. Examples include hinges, a flexible material, such as rubber, SMA's, hook and loop connectors, as well as other devices and materials that allow at least some flexibility in the filter 225.

A conformal material 505 is also shown along a joining surface of the filter 225, such as the surface of the filter 225 that faces the hull (not shown) and/or the surface(s) of each end cap 510A, 510B, and/or filter sections 520A, 520B. The conformal material 505 is configured to provide a flexible, conformal seal between the hull (not shown) and the filter 225 and facilitates sealing of irregularities in the hull, such as low spots and high spots, rough surfaces, fouling, among other surface irregularities. The conformal material 505 includes flexible materials, such as rubber, foams, silicone, and other flexible materials and may be coupled to the joining surface of the filter 225 by fasteners and/or adhesives. In one embodiment, the conformal material 505 is along the length L or the width W, but in other applications, the conformal material 505 is coupled to the entire joining surface of each end cap 510A, 510B, and filter sections 520A, 520B. Additionally, conformal material 505 may be disposed at each flexible interface 514 to provide a substantial seal between the hull (not shown) and the filter 225.

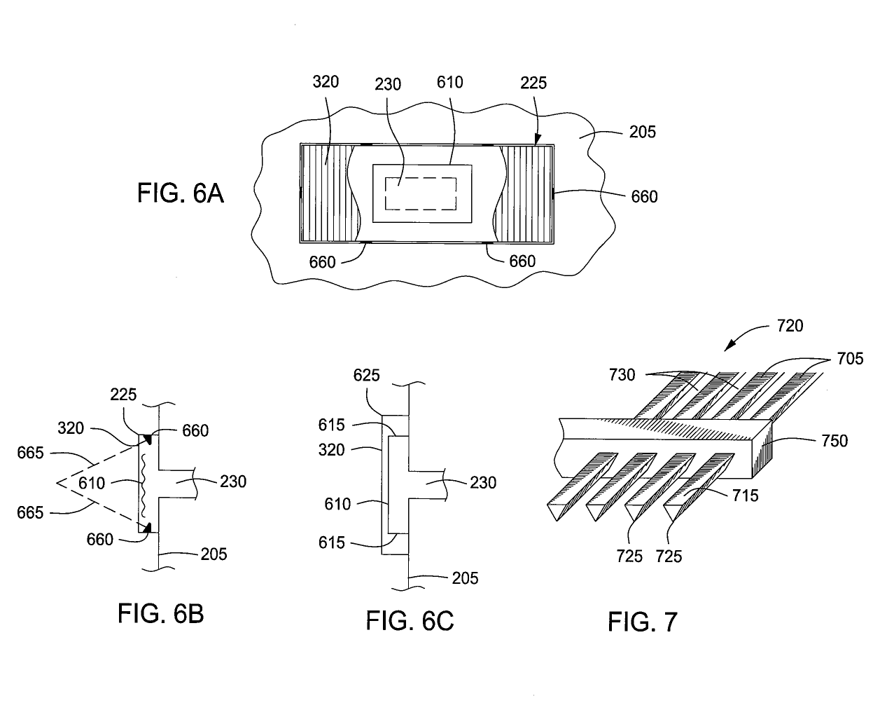

FIG. 6A is a top view of another embodiment of a filter 225 attached to a portion of the vessel hull 205. In this embodiment, the filter 225 includes a flow diversion device, such as a flow diverter 610, positioned over an opening 230 (shown in phantom) in the hull 205. The flow diverter 610 may be used in combination with the filters 225 as described herein and is adapted to equalize the flow velocity across an outer surface or a face of the filter 225. The flow diverter 610 may be sized to equal the size of the opening 230 or be slightly larger than the opening 230, and is configured to divert some water flow away from the center of the filter 225.

The flow diverter 610 may be a rectangular or circular plate or corrugated member made of corrosion resistant materials, such as polymers, elastomers, metals, and the like. The flow diverter 610 may be a solid plate, a perforated plate, a mesh material, a plurality of angled plates, or any combination thereof. The flow diverter 610 may be integral to the covering 320 of the filter 225, for example coupled to the inner surface or outer surface of the covering, or may be used to replace a portion of the covering 320 of the filter 225. In one embodiment, the flow diverter 610 may include a plurality of orifices or slots (not shown) that may be angled to divert the flow path of the water as it passes therethrough. While the opening 230 is shown as rectangular, the opening may be any shape, for example round, oval, or square. Also, the flow diverter 610 is shown as rectangular but may comprise any shape regardless of the shape of the opening 230. For example, the opening 230 may be round or circular and the flow diverter 610 may comprise a rectangular, a hexagonal shape, a triangular shape, or any other suitable shape.

In this embodiment, the filter 225 also includes a plurality of lighting devices 660 coupled to the frame of the filter 225, and are configured to provide optical energy in a manner that repels at least a portion of any marine life adjacent the face of the filter 225. In one embodiment, the plurality of lighting devices 660 are positioned and actuated to repel at least a portion of marine life from the vicinity of the filter 225. In one embodiment, each of the plurality of lighting devices 660 may be a strobe light configured to flash intermittently or synchronously. The lighting devices 660 may be powered by a battery (not shown) coupled to, or integral to, the frame of the filter 225. In some applications, the lighting devices 660 may be powered by a remote power source using cords or wires in communication with the lighting devices. The plurality of lighting devices 660 are directed outwardly (away from the hull 205) and are adapted to provide an irradiance of about 90 W/meter² at a distance of about 1.5 meters from the outer surface of the filter 225, further described in reference to FIG. 6B. In one application, the plurality of lighting devices 660 are strobe lights adapted to flash in a synchronous mode and in one specific application, the strobe lights are adapted to flash synchronously at a rate of about 250 to about 350 flashes per minute.

FIG. 6B is a side cross-sectional view of one embodiment of a flow diverter 610. In this embodiment, the flow diverter 610 is coupled to the inner surface of the filter 225 and positioned in front of the opening 230. The flow diverter 610 may be in contact with the inner surface of the covering 320, or may be spaced apart from the inner surface of the covering 320 to provide a space between the inner surface of the covering and the face of the flow diverter 610. The flow diverter 610 is shown as a corrugated member in this embodiment but may also be flat and may be coupled to the filter by fasteners, such as screws, bolts, rivets, mounting hardware, and the like. The flow diverter 610 may also be bonded by adhesives or welds to the filter 225, or may be adapted to be detachable from the filter 225 by magnetic attraction. Spacers (not shown) may be coupled to the flow diverter 610 to maintain spacing between the inner surface of the covering 320 and the face of the flow diverter 610, if needed.

In this embodiment, the filter 225 includes the lighting devices 660 as shown in FIG. 6A. As described above, the lighting devices 660 may be integral to the periphery of the filter 225 and are directed outward and away from the hull 205. In one embodiment, each of the plurality of lighting devices 660 are positioned to direct light at about a 45° angle from the plane of the covering 320 to define a light path 665 (shown as a dashed line). Each light path 665 may be configured to converge at about 1-2 meters in front of and at or near a geometric center of the filter 225. In this manner, an irradiance of about 90 W/meter² at a distance of about 1.5 meters from the outer surface of the filter 225 may be provided.

FIG. 6C is a side cross-sectional view of another embodiment of a flow diverter 610. In this embodiment, the flow diverter 610 includes a plurality of extensions 615 that serve as contact points and spacing devices between the backside of the flow diverter 610 and the hull 205. Each of the extensions 615 may be adapted to include a connection member, such as a magnet or suction device as described above, and the flow diverter 610 may be coupled to the hull 205 independently from the filter 225. For example, the flow diverter 610 may be positioned and attached to the hull 205 by a dockside or vessel crane, and/or divers may be used to position and attach the flow diverter 610 to the hull 205. After the flow diverter 610 is coupled to the hull, the filter 225 may be attached to the hull as described above.

FIG. 7 is an isometric view of a portion of one embodiment of a covering 720 that may be used as the covering 320 in the filters 225 shown in FIGS. 3-5 and 6A-6C. The covering 720 includes a plurality of filtering members 705. Filtering members may be profile bar, woven wire, perforated plate, or a layered combination thereof. In this embodiment the filtering members 705 are generally triangular or “V” shaped members having a flat side 715 opposing a point 725. In one application, the point 725 is facing the vessel during attachment to the vessel, and the flat side 715 is on the incoming water side of the filter. The filtering members 705 may be coupled to a structural member 750, which may be the support member 350 of FIG. 3 or the structural members 450 and 550 of FIGS. 4A and 5, respectively. The structural member 750 may be integral or suitably joined to each of the filtering members 705 by bonding, such as by adhesive bonding or welding. The structural member 750 may provide rigidity and maintenance of spacing of the filtering members 705 at substantially equal intervals to define a plurality of openings 730 therebetween. In one embodiment, each of the openings 730 is substantially equal and include a width of about 0.25 inches or less. In another embodiment, each of the openings 730 includes a width of about 0.05 inches or less.

The filters 225 described herein are adapted to facilitate suitable flow of water to the opening in the hull of a vessel while decreasing the velocity of the water flow across the filter In one embodiment, the filters 225 described herein facilitate an approach velocity, which may be defined as the incoming water velocity at a point perpendicular to and approximately three inches in front of the outer surface of the covering 320 (i.e. the upstream side or area outside of or opposite the intermediate area), that is between about 0.1 feet per second (fps) and about 1 fps. In one specific application, the filters may be configured to have an approach velocity of about 0.2 fps or less. The increased surface area of the filters allows a suitable and sufficient volume of water to enter the opening 230 while minimizing the flow velocity and/or equalizing the velocity gradient across the face of the filter.

The configuration of the covering 320 as described herein prevents marine life of a certain size from entering the opening 230, and the decreased approach velocity facilitated by the filters prevents or minimizes entrainment and impingement of the marine life against the outer surface of the covering. This, in turn, minimizes or eliminates introduction of the marine life into the opening in the hull while also minimizing or eliminating the possibility of injury or locational displacement to the marine life. In the event that debris and marine life may clog the openings in the covering, the filters may be cleaned periodically by personnel, either dockside by removing the filters from the hull, or in the water while the filters are coupled to the hull. In some applications, a flow of water or other suitable medium may be applied from the opening 230, or through external means to the interior of the filter 225 and/or covering 320, periodically, such that the flow is reversed through the filter and/or covering in order to remove the debris and/or marine life from the filter and/or covering, as needed. Once the covering has been cleared of debris and marine life, the pumping of incoming water may be resumed and/or maximized. In one embodiment, a bypass system is provided when excessive differential pressure is detected within the filter 225, which may indicate a clog at one or more filter sections or portions of the covering 320. In this embodiment, one or more filter sections or portions of the covering are adapted to allow water to bypass the obstructed filter portion in order to prevent potential damage to shipboard systems using the intake water.

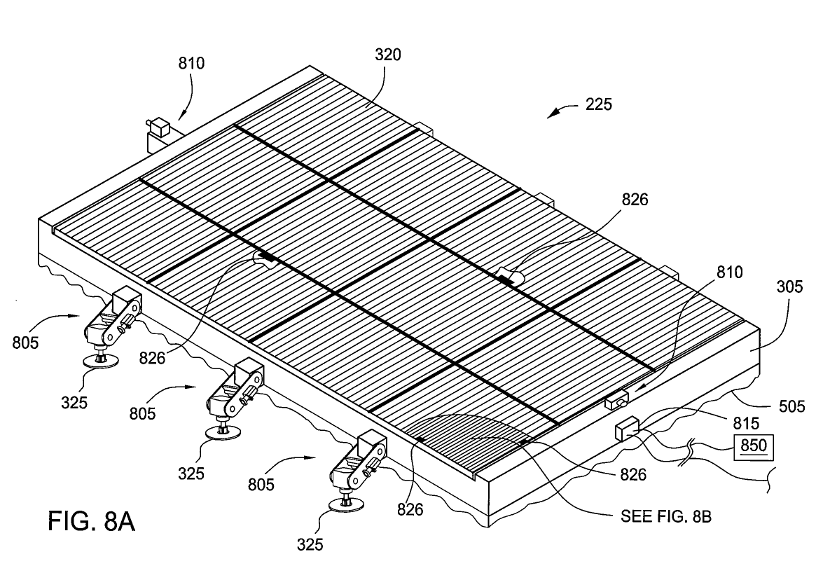

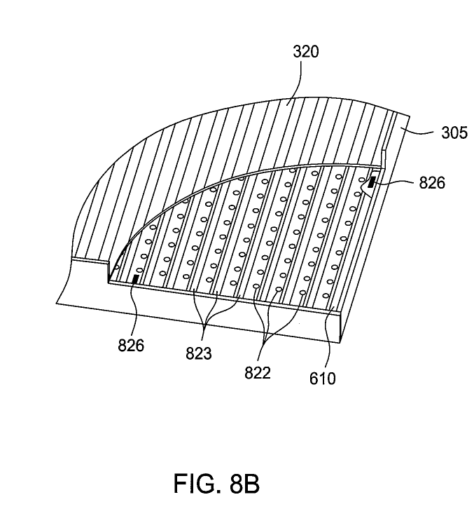

FIG. 8A is an isometric top view of another embodiment of a filter 225 that is similar to the filter 225 of FIG. 5. In this embodiment, the filter 225 includes a plurality of articulatable legs 805 coupled to a perimeter of the frame 305. Each of the articulatable legs 805 include a temporary connector 325 coupled thereto. In this embodiment, each of the temporary connectors 325 include a suction device or a magnetic material, such as an electromagnetic device. Additionally, the filter 225 includes one or more remote vision devices 810, which may be a camera and a lighting device that is coupled to the frame 305 or other portion of the filter 225. Each of the one or more remote vision devices 810 are adapted to provide operator feedback during deployment, retrieval and/or operation of the filter 225. The one or more remote vision devices 810 may be coupled to a motor providing rotation and/or movement relative to the frame 305, or may be fixed to the frame 305 in a position to view the vessel hull (not shown) during a deployment or retrieval exercise.

In this embodiment, the filter 225 includes one or more sensors 826 coupled to or within the filter 225. Each of the one or more sensors 826 may be disposed external or internal to the covering 320 in a manner that exposes each sensor to fluid flow during a water intake process. Each of the one or more sensors 826 may be a pressure sensor or transducer adapted to provide a metric of pressure across the entire filter or local pressure within the filter. In one aspect, the sensors 826 are adapted to provide a metric of pressure drop at local points within each filter section and provide a determination of the pressure drop across the entire surface area of the filter 225. In addition, one or more sensors 826 may be a velocity transducer to provide a metric of water velocity at the sensor location. The filter 225 also includes a control head 815 coupled to the frame 305. The control head 815 functions as a power and sensor control distribution panel and as an attachment junction for at least one umbilical cable, which provides power and input/output functions to and from the filter 225. At least one umbilical cable is coupled to a control module 850 that provides environmental and positional information to an operator. The filter 225 also includes a suitable number of attachment junctions on the frame 305 for at least one tether. The tether additionally provides support for the umbilical cable.

The filter 225 also includes a flow diverter 610 coupled to the frame 305. In this embodiment, the flow diverter 610 is coupled to the interior of the frame under the covering 320 and is adapted to function as a distribution plate to distribute and/or spread flow volume across the covering 320. While not shown, the flow diverter 610 in this embodiment spans the inside length and width of the frame 305 below the covering 320.

FIG. 8B is an isometric detail view of a portion of the filter 225 shown in FIG. 8A. In this view, a portion of the covering 320 is removed to show the flow diverter 610 in greater detail. The flow diverter 610 is configured as a perforated sheet having a plurality of orifices or openings 822 formed therethrough. Ridges or corrugated portions 823 may be provided to add structural rigidity to the flow diverter 610. Also shown is a plurality of sensors 826 that may be positioned between the covering 320 and the flow diverter 610 and below the flow diverter 610 in order to gauge pressure drop, water velocity, or a combination thereof.

In one aspect, the flow diverter 610 is adapted to spread out the concentrated fluid flow into the opening 230 (FIGS. 2-3B) across the entire area of the covering 320 during a water intake process. For example, if the filter 225 is applied to opening 230 with a water intake rate of 3,000 m³/hour and where the effective surface area of the covering 320 is 13.94 m², the flow volume is evenly spread across the entire 13.94 m² surface area of the covering 320. In this example, the linear velocity at points perpendicular to and approximately three inches in front of the outer surface of the covering 320 (i.e. the upstream side of the covering 320) is approximately 0.061 meters/second. Thus, the function of the flow diverter 610 is to reduce velocity gradients across the outer surface of the covering 320 by providing resistance to the localized concentration of fluid flow downstream of the covering 320. The pattern of openings 822 provide a flow restriction by directing concentrated flow to adjacent openings 822 with lower velocities, which spreads the intake flow across the entire area of the covering 320 and minimizes the velocity gradients across the covering 320.

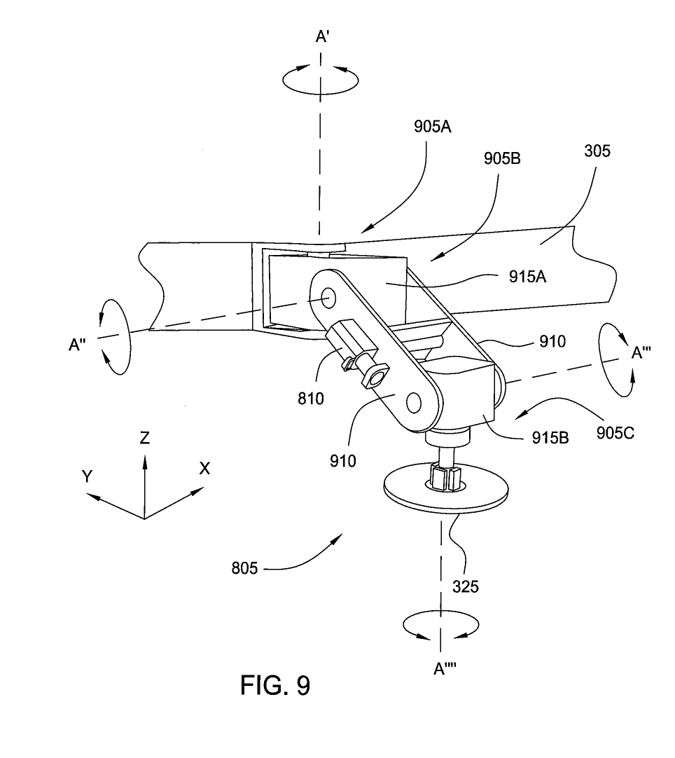

FIG. 9 is an isometric detail view of one embodiment of an articulatable leg 805. The articulatable leg 805 includes at least three movable segments 905A, 905B and 905C that are adapted to move independently relative to each other. The segment 905C includes a temporary connector 325 coupled thereto that may be magnetic device, a suction devices, or a vacuum device adapted to couple the filter 225 to the vessel hull 205 (not shown). In one embodiment, the temporary connector 325 is an electromagnetic device adapted to be remotely activated and deactivated to provide a desired coupling and decoupling to and from the vessel hull 205 in a deployment, intake, or retrieval process.

In one embodiment, the segments 905A, 905B and 905C include a hinged connection, such as a revolute joint, providing at least rotational movement in axes A′, A″, A′″ and A″″. The segments 905B and 905C are connected by linking members 910 that allow the segment 905C to be raised (in the Z direction) relative to the segment 905B. The segment 905A includes a movable joint that couples the frame 305 to a first actuator 915A. The segment 905B includes a movable joint that couples the first actuator 915A to the linking members 910. The segment 905C includes a movable joint that couples the linking members 910 to a second actuator 915B. The segment 905C also includes the temporary connector 325.

Each of the segments 905A, 905B and 905C are capable of movement in at least one degree of freedom. The segment 905A provides rotational movement along axis A′ allowing the segments 905B and 905C to move laterally (in the X direction). The segment 905B provides rotational movement along axis A″. The segment 905C provides rotational movement along axis A′″ and A″″. The combination of the rotational or pivoting movement provided by the segments 905A, 905B and 905C allows the articulatable leg 805, specifically the temporary connector 325, to move linearly in the X, Y and Z directions relative to the frame 305.

In one aspect, each of the movable segments 905A, 905B and 905C include actuators 915 adapted to provide motive force to each segment and move each segment relative to one another. The segments 905A and 905B may share a single actuator 915 adapted to provide movement in at least two axes or directions. Each of the actuators 915 may be electrically operated, hydraulically operated or pneumatically operated to provide motive force to each segment 905A, 905B and 905C.

In one embodiment, a remote vision device 810 is coupled to the articulatable leg 805. The remote vision device 810 may be a video camera and light adapted to provide operator feedback during deployment, operation, or retrieval of the filter 225. The remote vision device 810 may be coupled to a linking member 910 and may also include a motor (not shown) providing rotation and/or movement relative to the linking member 910. Alternatively, the remote vision device 810 may be fixed to the linking member 910 in a position to view the temporary connector 325, the screen surface and/or the vessel hull (not shown) during operations, a deployment or retrieval exercise. Each of the actuators 915 are configured for remote operation to allow an operator to move the filter 225 relative to the vessel hull 205 in a deployment or retrieval process, and position the filter 225 relative to the opening 230 in the vessel hull 205.

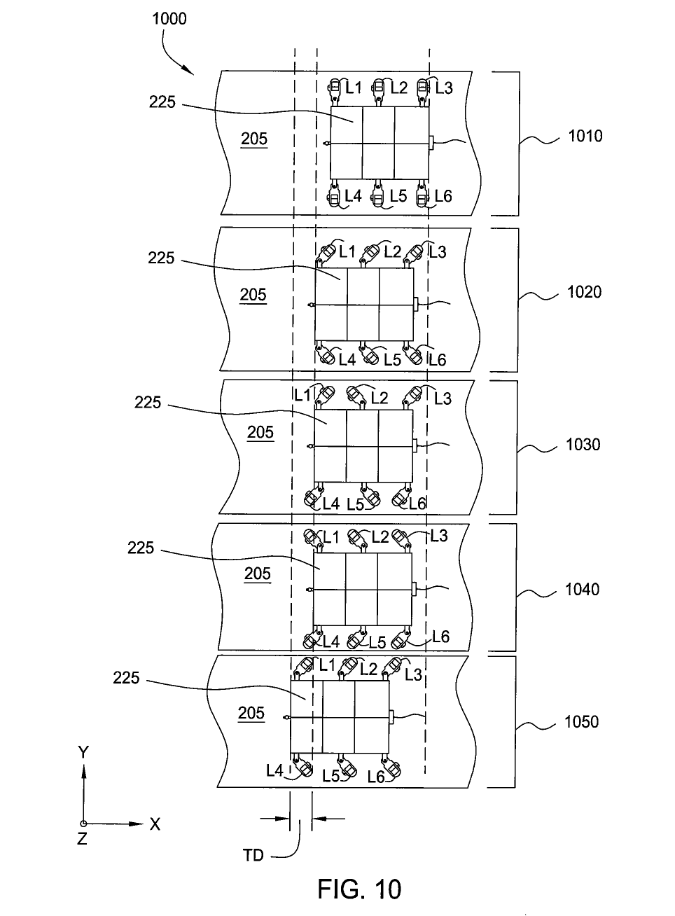

FIG. 10 shows one embodiment of a movement method 1000 for a filter 225 having a plurality of articulatable legs L₁-L₆ that are similar to the articulatable leg 805 described in FIG. 9. The movement sequence of the filter 225 described herein is provided to move the filter 225 relative to the vessel hull 205 and may be used in a deployment or retrieval exercise. In this embodiment, the movement sequence is described in a deployment mode but the movement sequencing of the filter may be adapted in a retrieval process as well.

In deploying the filter 225, the filter 225 may be positioned adjacent the vessel hull 205 by personnel on the docking facility (not shown) or positioned adjacent the vessel hull 205 from a deployment vessel (not shown), such as a boat or platform positioned alongside the vessel hull 205. The personnel on the docking facility or the deployment vessel may use a crane or lifting device to facilitate positioning of the filter 225 adjacent the vessel hull 205.

One or both of the deployment vessel and docking facility includes a control station having a control module 850 (FIG. 8A) to monitor and control the filter 225. In one embodiment, each filter 225 is in communication with a control module that includes control inputs, sensor readouts and monitors, alarm indicators and camera feeds. An operator receives directional orientation through real-time camera feeds displayed at the control module 850.

Sequence step 1010 includes decoupling the filter 225 from the crane or lifting device in a position adjacent the vessel hull 205 and then coupling the filter 225 to the vessel hull 205 with one or more of the temporary connectors 325 coupled to the articulatable legs L₁-L₆. In one embodiment, the adjacent position may be a position where the horizontal plane of the filter 225 is substantially parallel to or substantially equidistant to the general plane of a surface of the vessel hull 205. Substantially parallel or equidistant is understood as a parallel relationship equidistant relationship between a general plane of the vessel hull and the general plane of the filter 225 and includes curved surfaces of the vessel hull 205 and/or curved shapes of the filter 225. When the filter 225 is positioned relative to the vessel hull 205, the articulatable legs L₁-L₆ are oriented orthogonally relative to the frame (in the Y direction) and in a coplanar orientation (Z direction) relative to the plane of the filter 225 such that the temporary connectors 325 are substantially coplanar with the plane of the filter 225.

Sequence step 1010 also includes moving at least one articulatable leg on one side of the filter 225 and at least two articulatable legs on an opposing side to position the respective temporary connectors 325 coupled to the actuated articulatable legs to a position adjacent the vessel hull 205. When the respective temporary connectors 325 are adjacent the vessel hull 205, the temporary connectors 325 are actuated to fasten to the vessel hull 205. Moving the temporary connectors 325 may include actuating the respective articulatable legs toward the vessel hull 205 and out of the coplanar orientation with the filter 225 (in the Z direction). In one example of sequence step 1010, the temporary connectors 325 disposed on the articulatable legs L₁, L₃ and L₅ are actuated to fasten to the vessel hull 205, thus suspending the filter 225 relative to the vessel hull 205. In another example of sequence step 1010, all of the articulatable legs L₁-L₆ may be moved to a position adjacent the vessel hull 205 and each temporary connector 325 may be actuated to fasten the filter 225 to the vessel hull 205.

Sequence step 1020, includes pivoting the articulatable legs L₁-L₆ out of the orthogonal orientation with the frame 305 with the articulating legs remaining attached to the vessel hull 205 by the respective temporary connectors 325. The pivoting motion of the articulatable legs L₁-L₆ cause the filter 225 to move laterally (X direction) relative to the vessel hull 205.

Sequence step 1030 includes moving or raising (in the Z direction) at least one articulatable leg on one side of the filter 225 and at least two articulatable legs on an opposing side of the filter 225. Sequence step 1030 also includes then pivoting at remaining articulatable legs on each side of the filter 225. One example of sequence step 1030 includes de-actuating the temporary connectors 325 disposed on the articulatable legs L₂, L₄ and L₆ while the temporary connectors 325 disposed on the articulatable legs L₁, L₃ and L₅ are energized and holding the filter 225 on the vessel hull 205. In this example, the articulatable legs L₂, L₄ and L₆ are pivoted to move the temporary connectors 325 disposed thereon laterally (in the X direction) relative to the vessel hull 205. Once the articulatable legs L₂, L₄ and L₆ are pivoted about the Z-axis, the articulatable legs L₂, L₄ and L₆ lower (in the Z direction) to position the temporary connectors 325 disposed thereon adjacent the vessel hull 205. When the temporary connectors 325 are in position, the temporary connectors 325 disposed on the articulatable legs L₂, L₄ and L₆ are energized to fasten the filter 225 to the vessel hull 205. The final orientation of the articulating legs L₂, L₄ and L₆ following this step is shown in the illustration of sequence step 1030.

Sequence step 1040 includes de-energizing the temporary connectors 325 disposed on the articulatable legs L₁, L₃ and L₅ and raising (in the Z direction) the temporary connectors 325 disposed thereon away from the vessel hull 205. When the temporary connectors 325 disposed on the articulatable legs L₁, L₃ and L₅ are positioned away from the vessel hull 205, the articulatable legs L₁, L₃ and L₅ are pivoted about the Z-axis to move the temporary connectors 325 laterally (in the X direction) relative to the vessel hull 205. The final orientation of the articulating legs L₁, L₃ and L₅ following this step is shown in the illustration of sequence step 1040.

Sequence step 1050 includes pivoting the articulatable legs L₁-L₆ while the respective temporary connectors 325 remain attached to the vessel hull 205 to move the filter 225 laterally (in the X direction) relative to the vessel hull 225. The sequence steps 1010-1050 provide movement of the filter 225 relative to the vessel hull by a travel distance TD. The sequence steps 1020-1050 may be repeated as needed to move the filter 225 to a desired location on the vessel hull 205. In one embodiment, the travel distance TD is about 1 meter. Other movement sequences of the articulatable legs L₁-L₆ may be used to move the filter 225 vertically (in the Y direction) relative to the vessel hull 205. Diagonal movement may also be provided by manipulation of the articulatable legs L₁-L₆. Thus, desired lateral, vertical and diagonal positioning of the filter 225 may be provided to deploy the filter 225, retrieve the filter 225, and position the filter 225 relative to an opening 230 in the vessel hull 205.

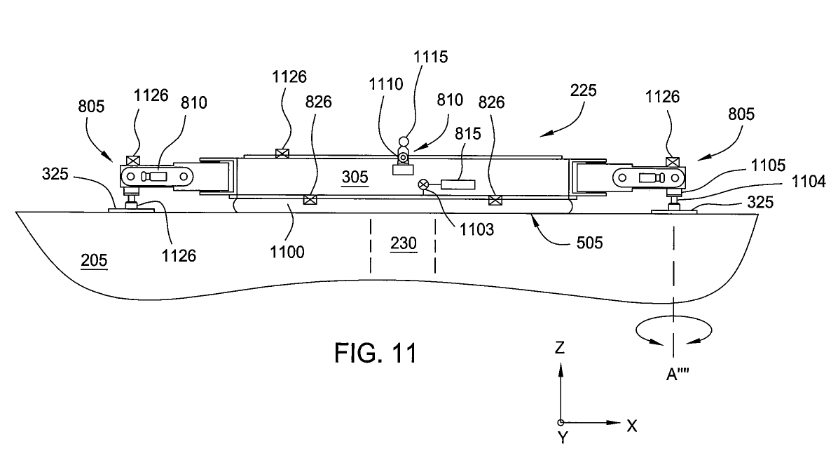

FIG. 11 is a side view of a filter 225 positioned on the vessel hull 205 adjacent an opening 230 (shown in phantom). When the filter 225 is positioned adjacent the opening 230 as desired, the temporary connectors 325 on each articulatable leg 805 are actuated. Each articulatable leg 805 may be locked or biased toward the vessel hull 205 to securely position the conformal material 505 against the vessel hull 205. The conformal material 505 provides a flexible, conformal seal between the vessel hull 205 and the frame 305. The conformal seal provides for the sealing of the conformal material to hull contours as well as facilitating sealing of irregularities in the vessel hull 205, such as low spots and high spots, rough surfaces, fouling, among other surface irregularities. The conformal material 505 includes flexible materials, such as rubber, foams, silicone, and other flexible materials and may be coupled to the joining surface of the filter 225 by fasteners and/or adhesives. Another function of the conformal material is to transfer and distribute any load forces from the screen to the hull. In one embodiment, the conformal material 505 includes a bladder 1100 adapted to facilitate sealing between the frame 305 and the vessel hull 205. In this embodiment, the bladder 1100 is coupled to a compressed fluid source, such as an air compressor, to facilitate inflation of the bladder 1100. The bladder 1100 is coupled to a valve 1103 to facilitate pressure regulation and/or deflation of the bladder 1100.

In one embodiment, each of the temporary connectors 325 includes a shaft 1104 and a positioning device 1105. The positioning device 1105 may be a swivel, a gimbal mechanism, a threaded member, or an actuator adapted to provide movement toward or away (in the Z direction) from the vessel hull 205. Thus, in one embodiment, the positioning device 1105 provides a fine adjustment of the filter 225 relative to the vessel hull 205. The assembly consisting of positioning device 1105, shaft 1104 and temporary connector 325 additionally provides for rotation about the A″″ axis. Also shown is a plurality of remote vision devices 810 coupled to the frame 305 and articulatable legs 805. In this embodiment, each of the remote vision devices 810 include a video camera 1110 and a lighting device 1115.

One or more sensors 826, such as a pressure sensor or a transducer, are in communication with the conformal material 505. In one embodiment, the one or more sensors are transducers that are adapted to provide a metric of the pressure inside the bladder 1100. Additionally other sensors 1126 may be coupled to other portions of the frame 305 and/or the articulatable legs 805. In this embodiment, each sensor 1126 includes a pressure sensor or transducer, or a proximity sensor that is adapted to provide a metric of distance between the frame 305 and other objects, such as the vessel hull 205. In one embodiment, each sensor 1126 disposed on the articulatable legs 805 is a transducer that is used to provide pressure metrics at points on the respective articulatable leg 805. Although articulatable legs are shown coupled to the filter 225 to provide motive force for moving the filter 225, other mechanisms may be used, such as wheels, tracks or other motive devices.

The apparatus and method described herein is adapted to protect certain fish species and other marine life in areas that may be protected, and also maintains the status quo in areas that are not currently protected by minimizing or preventing accidental injury, eradication, and dislocation of these species. This provides less of an environmental impact in an area that may be protected and may open up the possibilities for landing sites for commercial ventures. Also, the apparatus and method provides a smaller ecological footprint in areas where the vessel is docked or moored, as the marine population will not be significantly reduced or affected in the area around the docking facility.

While the foregoing is directed to embodiments of the present invention, other and further embodiments of the invention may be devised without departing from the basic scope thereof, and the scope thereof is determined by the claims that follow.

1. A filter, comprising:
a frame;
a plurality of movable legs, disposed around a perimeter of the frame;
at least one motor coupled to each of the plurality of movable legs;
a temporary connector coupled to each of the plurality of movable legs, each temporary connector being actuatable to couple to a hull of a marine vessel; and
a covering coupled between opposing sides of the frame to define a surface area that is at least two times greater than an area defined by the opening in the hull.

2. The apparatus of claim 1, wherein the covering comprises one or more modular sections coupled to the frame.

3. The apparatus of claim 1, wherein the frame comprises a conformal material on a surface of the frame adapted to couple to the hull.

4. The apparatus of claim 3, wherein the conformal material comprises a bladder.

5. The apparatus of claim 4, wherein the filter further comprises:
a flow diverter disposed in the interior of the frame downstream of the covering.

6. The apparatus of claim 5, wherein the flow diverter comprises a perforated plate having a dimension substantially equal to or less than an interior dimension of the frame.

7. The apparatus of claim 1, wherein each of the temporary connectors are selected from the group consisting of magnetic devices, suction devices, or combinations thereof.

8. The apparatus of claim 7, wherein each of the temporary connectors comprise electromagnets.

9. The apparatus of claim 1, wherein the filter further comprises:
a plurality of lighting devices coupled to the perimeter of the frame.

10. The apparatus of claim 9, wherein each of the plurality of lighting devices is coupled to a video camera.

11. A filter configured to attach to a hull of a vessel adjacent to an opening in the hull, the opening having an open area configured to receive a volume of water at first flow velocity, the filter comprising;
a frame and a covering attached to the frame having a surface area that is greater than the open area and defining an interstitial space between the hull and an interior surface of the covering;
a perforated plate disposed in the interstitial space and coupled to the frame;
a plurality of sensors coupled to the frame; and
a plurality of temporary connectors spaced along the perimeter of the frame, wherein the covering reduces the flow of water upstream of the covering to a second flow velocity that is less than the first flow velocity.

12. The apparatus of claim 11, wherein the temporary connectors are magnets.

13. The apparatus of claim 11, wherein the covering comprises:
a plurality of substantially parallel and spaced apart filtering members coupled to the frame.

14. The apparatus of claim 13, wherein the plurality of filtering members are selected from the group consisting of a triangular-shaped wire, profile bar, woven screen, or combinations thereof

15. The apparatus of claim 11, further comprising:
a plurality of video cameras coupled to the perimeter of the frame.

16. The apparatus of claim 15, further comprising:
a lighting device coupled to a perimeter of the frame.

17. A method for filtering marine species from water surrounding a marine vessel, comprising:
coupling a removable filter to the marine vessel over an opening in the hull;
moving water through an area exterior to an outer surface of the removable filter at a first velocity; and
moving the filtered water through the opening in the hull at a second velocity that is greater than the first velocity.

18. The method of claim 17, wherein the first velocity is between about 0.1 fps to about 1 fps.

19. The method of claim 17, wherein the area exterior to the outer surface of the filter includes about 2 inches to about 4 inches measured at 900 from the outer surface of the filter.

20. The method of claim 17, wherein the coupling further comprises coupling the removable filter to the marine vessel when the vessel is docked.

21. The method of claim 17, wherein the coupling comprises coupling the filter to the hull magnetically.
